(19) United States
(12) Patent Application Publication
(10) Pub. No.: US 2008/0241637 A1
(43) Pub. Date: Oct. 2, 2008

(54) Polymerizable Compositions for Bonding and Sealing Low Surface Energy Substrates for Fuel Cells

(76) Inventor: Matthew P. Burdzy, South Windsor, CT (US)

Correspondence Address: LOCTITE CORPORATION, 1001 TROUT BROOK CROSSING, ROCKY HILL, CT, 06067, US

(21) Appl. No.: 10/597,180

(22) PCT Filed: Jan. 20, 2005
(86) PCT No.: PCT/US2005/001985

§ 371 Date: Jul. 14, 2006

Related U.S. Application Data
(60) Provisional application No. 60/538,358, filed on Jan. 22, 2004.

(51) Int. Cl. H01M 8/02

(52) U.S. Cl. 429/36; 429/35

(57) ABSTRACT

An electrochemical cell, such as a fuel cell, having improved sealing against leakage includes (a) a first electrochemical cell component having a mating surface; (b) a cured sealant composition adhesively bonded to the mating surface of the first electrochemical cell component and (c) a second electrochemical cell component having a mating surface abuttingly disposed over the cured sealant composition. The cured sealant composition includes reaction products of a polymerizable (meth)acrylate component and a boron-containing initiator. Such a sealant composition is particularly useful where the mating surface of the first electrochemical cell component and/or the mating surface of the second electrochemical cell component is a plastic or plastic-containing substrate.

### FIELD OF THE INVENTION

The present invention relates to a method and a composition for bonding and sealing components of an electrochemical cell, such as a fuel cell, and an electrochemical formed therefrom. More particularly, the present invention relates to a method and to a composition for bonding and sealing plastic or plastic-containing fuel cell components, such as membrane electrode assemblies, fluid flow plates, proton exchange membranes, and combinations thereof.

### BRIEF DESCRIPTION OF RELATED TECHNOLOGY

Although there are various known types of electrochemical cells, one common type is a fuel cell, such as a proton exchange membrane (PEM) fuel cell. The PEM fuel cell contains a membrane electrode assembly (MEA) provided between two flow field or bipolar plates. Gaskets are used between the bipolar plates and the MEA to provide seals thereat. Additionally, since an individual PEM fuel cell typically provides relatively low voltage or power, multiple PEM fuel cells are stacked to increase the overall electrical output of the resulting fuel cell assembly. Sealing is also required between the individual PEM fuel cells. Moreover, cooling plates are also typically provided to control temperature within the fuel cell. Such plates are also sealed to prevent leakage within the fuel cell assembly. After assembling the fuel cell stack is clamped to secure the assembly.

To reduce cost and weight fuel cell components are being made of plastic or plastic containing materials. The sealing and/or bonding of such plastic or plastic containing materials, however, is difficult, one reason for which is the general difficulty in wetting the surfaces of these materials with a sealant to provide an adequate bond or seal thereat. Further, multiple fuel cells are typically stacked to form a fuel cell assembly, and an inadequate seal at one component of a fuel cell will effect the entire fuel cell assembly.

Thus, there is a need for an improved sealant composition suitable for use with electrochemical cell components, especially fuel cell components constructed from plastic or plastic-containing materials.

### SUMMARY OF THE INVENTION

The present invention is directed to an electrochemical cell, such as a fuel cell, having improved sealing against leakage. The electrochemical cell includes (a) a first electrochemical cell component having a mating surface; (b) a cured sealant composition disposed over the mating surface of the first electrochemical cell component and (c) a second electrochemical cell component having a mating surface abuttingly disposed over the cured sealant composition to provide a seal thereat. The cured sealant composition advantageously includes the reaction products of a polymerizable (meth)acrylate component and a boron-containing initiator. Such a sealant composition is particularly useful where the mating surface of the first cell is a plastic or plastic-containing substrate. Further, the sealant composition may be adhesively bonded to the mating surface of the first electrochemical cell component.

The plastic or plastic-containing substrate may include an electrically conductive substrate, a thermally conductive substrate and combinations thereof. The plastic or plastic-containing substrate may be electrically conductive or may include electrically conductive particles. Further, the plastic or plastic-containing substrate may be a molded substrate, such as an injection molded substrate, a compression molded substrate and combinations thereof. Alternatively, the plastic or plastic-containing substrate may be a machined substrate or a vacuum-formed substrate.

The cured sealant composition may or may not be adhesively bonded to the mating surface of the second cell component. When the composition is adhesively bonded to the mating surface of the second cell, the composition acts as a formed-in-place gasket. When the composition is not adhesively bonded to the mating surface of the second cell, the composition acts as a cured-in-place gasket. The first cell component may vary and is typically a cathode flow field plate, an anode flow field plate, a gas diffusion layer, an anode catalyst layer, a cathode catalyst layer, a membrane electrolyte, a membrane-electrode-assembly frame, and combinations thereof. Similarly, the second cell component is typically also a cathode flow field plate, an anode flow field plate, a gas diffusion layer, an anode catalyst layer, a cathode catalyst layer, a membrane electrolyte, a membrane-electrode-assembly frame, and combinations thereof, provided that the second cell component is different from the first cell component.

Desirably, the cured sealant composition includes a curable (meth)acrylate component, where the curable (meth)acrylate component includes a mono-functional (meth)acrylate component, a poly-functional (meth)acrylate component, and combinations thereof. Useful boron-containing initiators include alkyl borohydrides (such as metal and ammonium alkyl borohydrides), complexes of organoborane and polyaziridine, and complexes of trialkyl borane or alkyl cycloalkyl borane and amine compounds.

Methods for forming electrochemical cells, such as fuel cells, are also provided. In one aspect of the present invention, a method for forming an electrochemical cell includes the steps of (a) providing a first and a second electrochemical cell component each having a mating surface; (b) applying a curable sealant composition to the mating surface of at least one of the first electrochemical cell component or the second electrochemical cell component, where the curable sealant composition comprises a polymerizable (meth)acrylate component and a boron-containing initiator; (c) curing the sealant composition; and (d) aligning or mating the mating surface of the second electrochemical cell component with the mating surface of the first electrochemical cell component.

In another aspect of the present invention, a method for forming an electrochemical cell includes the steps of (a) providing a first electrochemical cell component having a mating surface; (b) aligning or mating a mating surface of a second electrochemical cell component with the mating surface of the first electrochemical cell component; (c) applying a curable sealant composition to at least a portion of the mating surface of at least one of the first or second electrochemical cell components, where the curable sealant composition comprises a polymerizable (meth)acrylate component and a boron-containing initiator; and (d) curing the sealant composition.

### BRIEF DESCRIPTION OF THE DRAWINGS

FIG. 1 is a cross-sectional view of a fuel cell having an anode flow field plate, a gas diffusion layer, an anode catalyst, a proton exchange membrane, a cathode catalyst, a second gas diffusion layer, and a cathode flow field plate.

FIG. 2 is a cross-sectional of a fuel cell having a sealant disposed between a cathode flow field plate and an anode flow field plate, between the anode flow field plate and a gas diffusion layer, between a gas diffusion layer and a second cathode flow field plate, and between the second cathode flow field plate and a second anode flow field plate.

FIG. 3 is a cross-sectional of a fuel cell having a sealant disposed between a cathode flow field plate and an anode flow field plate, between the anode flow field plate and an anode catalyst, between a cathode catalyst and a second cathode flow field plate, and between the second cathode flow field plate and a second anode flow field plate.

FIG. 4 is a cross-sectional of a fuel cell having a sealant disposed between a cathode flow field plate and an anode flow field plate, between the anode flow field plate and a proton exchange membrane, between the proton exchange membrane and a second cathode flow field plate, and between the second cathode flow field plate and a second anode flow field plate.

FIG. 5 is a cross-sectional of a fuel cell having a sealant disposed between a cathode flow field plate and an anode flow field plate, between the anode flow field plate and a membrane electrode assembly, between the membrane electrode assembly and a second cathode flow field plate, and between the second cathode flow field plate and a second anode flow field plate.

FIG. 6 is a partial cross-sectional view of adjacent fuel cell components having opposed mating surfaces with a cured-in-place sealant composition disposed on one of the mating surfaces.

FIG. 7 is a partial cross-sectional view of adjacent fuel cell components of FIG. 6 having the cured-in-place sealant composition sealing both of the mating surfaces.

FIG. 8 is a partial cross-sectional view of adjacent fuel cell components having opposed mating surfaces with a cured-in-place sealant composition in the form of a bead disposed on one of the mating surfaces.

FIG. 9 is a partial cross-sectional view of adjacent fuel cell components having opposed mating surfaces with a formed-in-place sealant composition sealing both of the mating surfaces.

FIG. 10 is a partial cross-sectional view of adjacent fuel cell components having opposed mating surfaces, one of which having a recess, with a cured-in-place sealant composition in the form of a bead disposed on one of the mating surfaces.

FIG. 11 is a partial cross-sectional view of adjacent fuel cell components having opposed mating surfaces, one of which having a recess, with a formed-in-place sealant composition sealing both of the mating surfaces.

FIG. 12 is a partial cross-sectional view of adjacent fuel cell components having opposed mating surfaces, both of which having a recess, with a cured-in-place sealant composition in the form of a bead disposed on one of the mating surfaces.

FIG. 13 is a partial cross-sectional view of adjacent fuel cell components having opposed mating surfaces, both of which having a recess, with a formed-in-place sealant composition sealing both of the mating surfaces.

FIG. 14 is a partial cross-sectional view of adjacent fuel cell components having opposed mating surfaces, both of which having a recess, with a cured-in-place sealant composition in the form of a bead disposed on both of the mating surfaces.

FIG. 15 is a partial cross-sectional view of adjacent fuel cell components having opposed mating surfaces, both of which having a recess, with a formed-in-place sealant composition sealing both of the mating surfaces.

FIG. 16 is a partial cross-sectional view of adjacent fuel cell components having opposed mating surfaces, one of which having a recess and the other having a pair of protuberances, with a cured-in-place sealant composition in the form of a bead disposed within the recess.

FIG. 17 is a partial cross-sectional view of adjacent fuel cell components having opposed mating surfaces, one of which having a recess and the other having a pair of protuberances, with a formed-in-place sealant composition sealing both of the mating surfaces.

FIG. 18 is a partial cross-sectional view of adjacent fuel cell components having opposed mating surfaces, one of which having a recess and the other having a protuberance, with a cured-in-place sealant composition in the form of a bead disposed substantially within the recess.

FIG. 19 is a partial cross-sectional view of adjacent fuel cell components having opposed mating surfaces, one of which having a recess and the other having a protuberance, with a formed-in-place sealant composition sealing both of the mating surfaces.

FIG. 20 is a partial cross-sectional view of adjacent fuel cell components having opposed mating surfaces, one of which having a recess and the other having a protuberance, with a cured-in-place sealant composition in the form of a bead disposed partially within the recess.

FIG. 21 is a partial cross-sectional view of adjacent fuel cell components having opposed mating surfaces, one of which having a recess and the other having a protuberance, with a formed-in-place sealant composition sealing both of the mating surfaces.

### DETAILED DESCRIPTION OF THE INVENTION

The present invention is directed to a method for bonding and compositions for bonding plastic or plastic-containing components of an electrochemical cell. As used herein, an electrochemical cell is a device which produces electricity from chemical sources, including but not limited to chemical reactions and chemical combustion. Useful electrochemical cells include fuel cells, dry cells, wet cells and the like. A fuel cell, which is described in greater detail below, uses combustion of chemicals reactants to produce electricity. A wet cell has a liquid electrolyte. A dry cell has an electrolyte absorbed in a porous medium or otherwise restrained from being flowable.

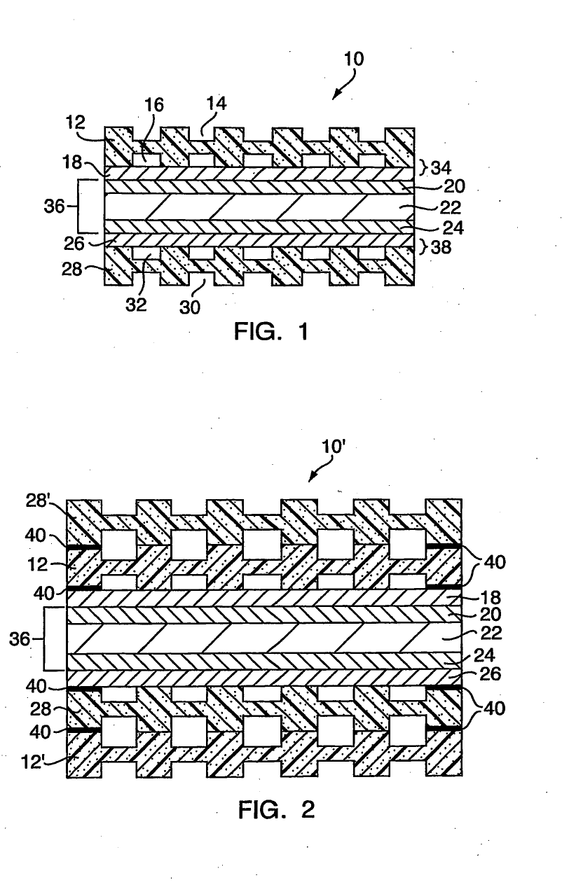

FIG. 1 shows a cross-sectional view of the basic elements of an electrochemical fuel cell, such as fuel cell 10. Electrochemical fuel cells convert fuel and oxidant to electricity and reaction product. Fuel cell 10 consists of an anode flow field plate 12 with open face coolant channels 14 on one side and anode flow channels 16 on the second side, a gas diffusion layer 18, an anode catalyst 20, a proton exchange membrane 22, a cathode catalyst 24, a second gas diffusion layer 26, and a cathode flow field plate 28 with open face coolant channels 30 on one side and cathode flow channels 32 on the second side, interrelated as shown in FIG. 1. The anode catalyst 20, the proton exchange membrane 22 and the cathode catalyst 24 combinations is often referred to as a membrane electrode assembly 36. Gas diffusion layers 18 and 26 are typically formed of porous, electrically conductive sheet material, such as carbon fiber paper. The present invention is not, however, limited to the use of carbon fiber paper and other materials may suitably be used. Fuel cells are not, however, limited to such a depicted arrangement of components. The anode and cathode catalyst layers 20 and 24 are typically in the form of finely comminuted platinum. The anode 34 and cathode 38 are electrically coupled (not shown) to provide a path for conducting electrons between the electrodes to an external load (not shown). The flow field plates 12 and 28 are typically formed of graphite impregnated plastic, compressed and exfoliated graphite; porous graphite; stainless steel or other graphite composites. The plates may be treated to effect surface properties, such as surface wetting, or may be untreated. The present invention is not, however, limited to the use of such materials for use as the flow field plates and other materials may suitably be used. Moreover, the present invention is not limited to the fuel cell components and their arrangement depicted in FIG. 1. For example, a direct methanol fuel cell (DMFC) can consist of the same components shown in FIG. 1 less the coolant channels. Further, the fuel cell 10 can be designed with internal or external manifolds (not shown).

At anode 34, a fuel (not shown) traveling through the anode flow channels 16 permeates the gas diffusion layer 18 and reacts at the anode catalyst layer 20 to form hydrogen cations (protons), which migrate through the proton exchange membrane 22 to cathode 38. The proton exchange membrane 22 facilitates the migration of hydrogen ions from the anode 34 to the cathode 38. In addition to conducting hydrogen ions, the proton exchange membrane 22 isolates the hydrogen-containing fuel stream from the oxygen-containing oxidant stream.

At the cathode 38, oxygen-containing gas, such as air or substantially pure oxygen, reacts with the cations or hydrogen ions that have crossed the proton exchange membrane 22 to form liquid water as the reaction product. The anode and cathode reactions in hydrogen/oxygen fuel cells are shown in the following equations:

Anode reaction: H₂→2H⁺+2e⁻ (I)

Cathode reaction: ½O₂+2H⁺+2e⁻→H₂O (II)

In a single cell arrangement, fluid-flow field plates are provided on each of the anode and cathode sides. The plates act as current collectors, provide support for the electrodes, provide access channels for the fuel and oxidant to the respective anode and cathode surfaces, and provide channels in some fuel cell designs for the removal of water formed during operation of the cell. In multiple cell arrangements, the components are stacked to provide a fuel cell assembly having a multiple individual fuel cells. Two or more fuel cells 10 can be connected together, generally in series but sometimes in parallel, to increase the overall power output of the assembly. In series arrangements, one side of a given plate serves as an anode plate for one cell and the other side of the plate can serve as the cathode plate for the adjacent cell. Such a series connected multiple fuel cell arrangement is referred to as a fuel cell stack (not shown), and is usually held together in its assembled state by tie rods and end plates. The stack typically includes manifolds and inlet ports for directing the fuel and the oxidant to the anode and cathode flow field channels.

FIG. 2 shows a cross-sectional view of the basic elements of fuel cell 10 in which certain of the adjacent elements have a cured or curable composition 40 therebetween to provide a fuel assembly 10′. As depicted in FIG. 2, composition 40 seals and/or bonds the anode field plate 12 to the gas diffusion layer 18. The cathode field plate 28 is also sealed and/or bonded to the gas diffusion layer 26. In this embodiment, fuel cell assembly 10′ often has a preformed membrane electrode assembly 36 anode with the anode catalyst 20 and the cathode catalyst 24 disposed thereon. The composition 40 disposed between the various components of the fuel cell assembly 10′ may be the same composition or may be different compositions. Additionally, as depicted in FIG. 2, composition 40 may seal and/or bond the anode flow field plate 12 to a component of a second fuel cell, such as a second cathode flow plate 28′. Further, as depicted in FIG. 2, composition 40 may seal and/or bond the cathode flow field plate 28 to a component of a third fuel cell, such as a second anode flow plate 12′. In such a manner, the fuel cell assembly 10′ is formed of multiple fuel cells having components sealingly and/or adhesively adjoined to provide a multiple cell electrochemical device.

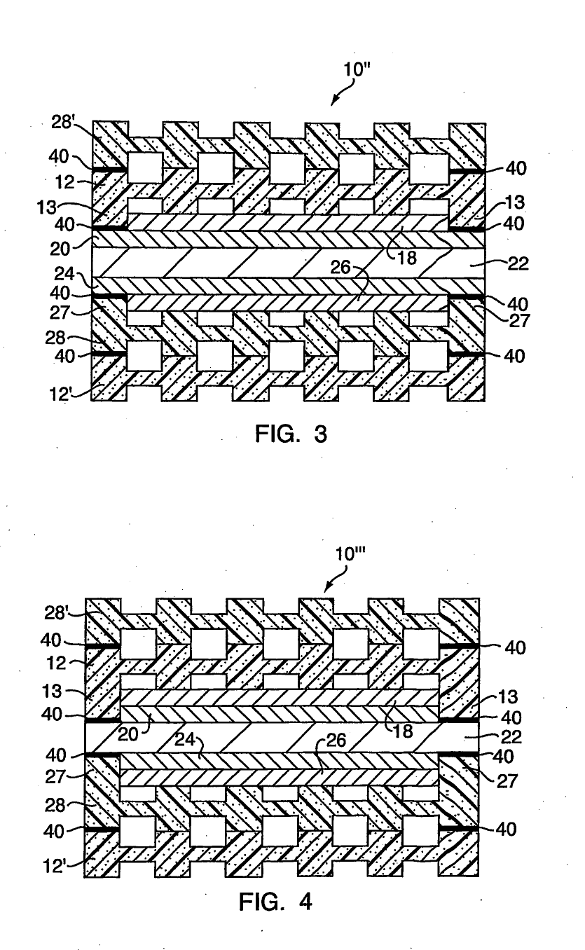

FIG. 3 shows a cross-sectional view of the basic elements of fuel assembly 10″ in which certain of the adjacent elements have a cured or curable composition 40, which may be the same or different, therebetween. In this embodiment of the present invention, the gas diffusion layer 18 is disposed between elongated terminal walls 13 of the anode flow field plate 12, and the gas diffusion layer 26 is disposed between elongated terminal walls 27 of the cathode flow field plate 28. Composition 40 is used to seal and/or bond the anode flow field plate 12 to the anode catalyst 20 and to seal and/or bond the cathode flow field plate to the cathode catalyst 24.

FIG. 4 shows a cross-sectional view of the basic elements of fuel assembly 10′″ in which certain of the adjacent elements have a cured, or curable composition 40, which may be the same or different, therebetween. In this embodiment of the present invention, the gas diffusion layer 18 and the anode catalyst 20 are disposed between the elongated terminal walls 13 of the anode flow field plate 12, and the gas diffusion layer 26 and the cathode catalyst 24 are disposed between the elongated terminal walls 27 of the cathode flow field plate 28. Composition 40 is used to seal and/or bond the anode flow field plate 12 to the proton exchange membrane 22 and to seal and/or bond the cathode flow field plate to the proton exchange membrane 22.

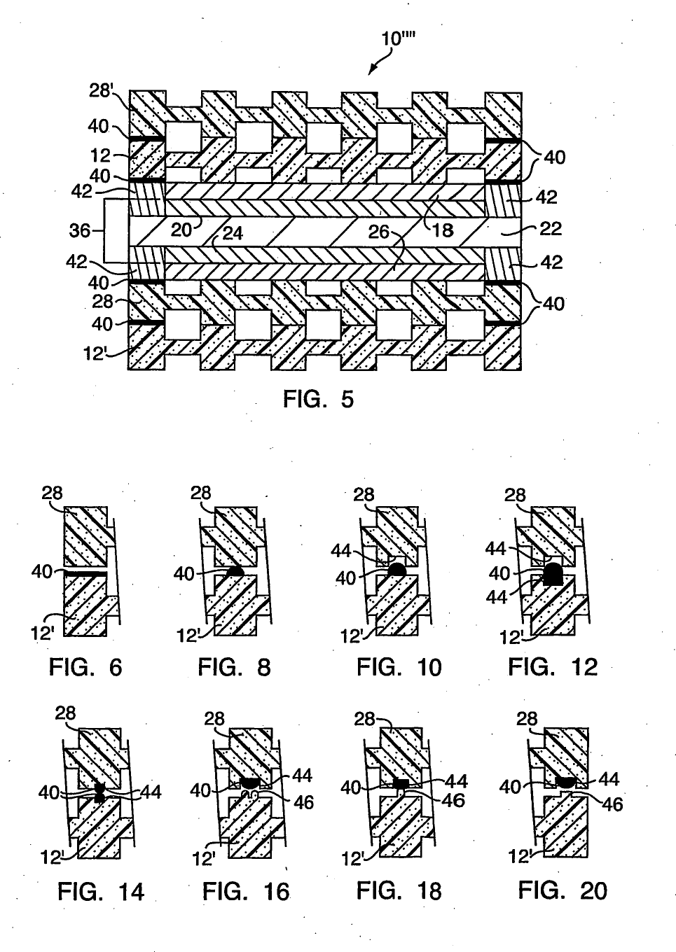

FIG. 5 shows a cross-sectional view of the basic elements of fuel assembly 10″″ in which certain of the adjacent elements have a cured or curable composition 40, which may be the same or different, therebetween. In this embodiment of the present invention, the gas diffusion layer 18 and the anode catalyst 20 are disposed between a membrane electrode assembly frame 42 of the membrane electrode assembly 36, and the gas diffusion layer 26 and the cathode catalyst 24 are disposed between a membrane electrode assembly frame 42 of the membrane electrode assembly 36. Composition 40 is used to seal and/or bond the anode flow field plate 12 to the membrane electrode assembly frame 42 and to seal and/or bond the cathode flow field plate to the membrane electrode assembly frame 42.

Composition 40 may be a cured-in-place or a formed-in-place composition thereby acting as a cured-in-place or a formed-in-place gasket. As used herein, the phrase “cured-in-place” and it variants refer to a composition applied to the surface of one component and cured thereat. Sealing is achieved through compression of the cured material during assembly of the one component with another component. The composition is typically applied in precise patterns by tracing, screen-printing or the like. Moreover, the composition may be applied as a film onto a substrate. Such application techniques are amenable to large scale or large volume production. As used herein, the phrase “formed-in-place” and its variants refer to a composition that is placed between two assembled components and is cured to both components. The use of the polymerizable composition as a formed-in-place and/or as a cured-in-place gasket allows for modular or unitized fuel assembly stack designs. Desirably, the composition is a compressible composition to facilitate sealing upon assembly of the fuel assembly stack designs.

Different mating surfaces of adjacent fuel cell components useful with cure-in-place and formed-in-place compositions are depicted in FIGS. 6-21. In FIGS. 6-21 the adjacent fuel cell components are shown as the cathode flow field plate 28 and the anode flow field plate 12′, however, other adjacent fuel cell components may suitably be used with the present invention. As used herein the phrase “mating surface” and its variants refer to a surface of a substrate that is proximally alignable to another substrate such that a seal may be formed therebetween.

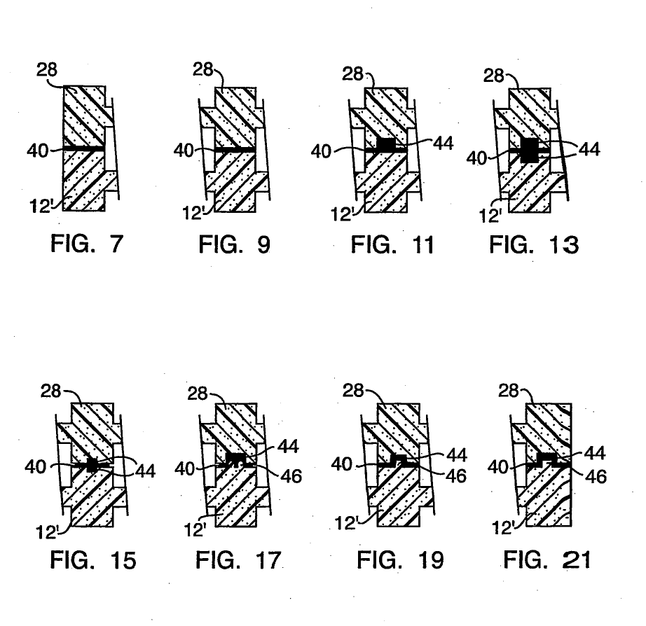

As depicted in FIG. 6, composition 40 may be formed as a cured-in-place gasket where the composition 40 is disposed and cured onto the anode flow field plate 12′, but not curably disposed onto the cathode flow field plate 28. As depicted in FIG. 7, when the fuel assembly is assembled, the flow field plate 12′ and the cathode flow field plate 28 are compressed against one and the other whereby composition 40 acts as a cure-in-plane gasket. Composition 40 is adhesively and sealingly bonded to the flow field plate 12′, but only sealingly engages the cathode flow field plate 28. Thus, the fuel cell assembly may be easily dissembled at this junction because composition 40 is not adhesively bonded to the cathode flow field plate 28.

As depicted in FIG. 9, composition 40 may be a formed-in-place composition where the composition 40 sealingly and adhesively bonds the cathode flow field plate 28 to the flow field plate 12′. As depicted in FIGS. 6, 7 and 9, the composition 40 is shown as being a flat planar strip. The present invention, however, is not so limited.

As depicted in FIG. 8, composition 40 is a cure-in-place gasket and disposed as a bead onto the anode flow field plate 12′. The composition 40 sealingly engages the cathode flow field plate 28 upon assembly of the fuel cell components. Additionally, as depicted in FIG. 10, the cathode flow field plate 28 may have a recess 44 for receiving a portion of the cured composition 40 upon assembly of the fuel cell components. Still further, as depicted in FIGS. 12 and 14, both the cathode flow field plate 28 and the anode flow field plate 12′ may each have a recess 44. The composition 40 may be applied as a cured-in-place gasket into one of the recesses, as depicted in FIG. 12, or into both of the recesses as depicted in FIG. 14. Still further, as depicted in FIGS. 16, 18 and 20, the composition 40 may be applied as a cured-in-place composition into the recess 44 of a fuel cell component, such as the cathode flow field plate 28, and the adjacent mating fuel cell component, for example the anode flow field plate 12′, may have a protuberance or protuberances. 46 which engage the cured composition 40 upon assembly of the fuel cell. Such mating surfaces, such as the mating recesses 44 and the mating protuberances 46 desirably aid in providing improved sealing of the adjacent and mating fuel cell elements upon assembly or compression of the fuel cell assembly.

As depicted in FIGS. 11, 13, 15, 17, 19 and 21, composition 40 may be used as a formed-in-place gasket where either of both the adjacent mating surfaces have a recess and/or a protuberance. For example, as depicted in FIGS. 11, 13 and 15 one or both of the adjacent fuel cell components, such as the cathode flow field plate 28 and the anode flow field plate 12′, may have a recess 44 into which the composition 40 may be disposed and cured. Further, as depicted in FIGS. 17, 19 and 21, a fuel cell component, for example the anode flow field plate 12′, may have a protuberance or protuberances 46 which engage the area or a portion of the area of the adjacent mating recess 44 and further which engages the cured composition 40.

To reduce cost and weight of the fuel cell or fuel cell assembly 10 a substrate, including a mating surface, of a fuel cell component may be a plastic or plastic-containing substrate. Desirably, the plastic or plastic-containing substrate is a conductive substrate. Such a conductive substrate may be an electrically conductive substrate, a thermally conductive substrate and combinations thereof. The plastic or plastic-containing substrate may be electrically conductive or may include electrically conductive particles, for example graphite particles. Further, the plastic or plastic-containing substrate may be a molded substrate. Such a molded substrate is desirably selected from the group consisting of an injection molded substrate, a compression molded substrate and combinations thereof. Alternatively, the substrate may be a machined substrate or a vacuum-formed substrate.

The plastic or plastic-containing substrate is typically a low surface energy substrate, e.g. one having a surface energy of less than 45 mJ/m², more particularly polyolefins including polyethylene and polypropylene, acrylonitrile-butadiene-styrene and polytetrafluoroethylene, or relatively low surface energy substrates such as polycarbonate. Such a substrate typically includes a C—R surface group, where R is H or halogen. Due to the low surface energy of these substrates, application of a curable sealant composition is often difficult because the curable composition does not adequately wet the surface of the substrate. Fuel components having a plastic or plastic-containing substrate include, but are not limited to, a cathode flow field plate, an anode flow field plate, a gas diffusion layer, an anode catalyst layer, a cathode catalyst layer, a membrane electrolyte, a membrane-electrode-assembly frame, and combinations thereof.

In one aspect of the present invention, an electrochemical cell, such as a fuel cell, includes (a) a first electrochemical cell component having a mating surface; (b) a cured sealant composition adhesively bonded to the mating surface of the first electrochemical cell component, where the cured sealant composition includes reaction products of a polymerizable (meth)acrylate component and a boron-containing initiator; and (c) a second electrochemical cell component having a mating surface abuttingly disposed over the cured sealant composition.

Desirably, the cured sealant composition used in the present invention includes a curable (meth)acrylate component. More desirably, the curable (meth)acrylate component includes a mono-functional (meth)acrylate component, a poly-functional (meth)acrylate component, and combinations thereof.

Desirably, the mono-functional (meth)acrylate component is embraced by compounds of the general structure:

CH₂═C(R)COOR¹

where R is H, CH₃, C₂H₅ or halogen, and

R¹ is C₁₋₈ mono- or bicycloalkyl, a 3 to 8-membered heterocyclic radial with a maximum of two oxygen atoms in the heterocycle, H, alkyl, hydroxyalkyl or aminoalkyl where the alkyl portion is C₁₋₈ straight or branched carbon atom chain.

Desirably, the poly-functional (meth)acrylate component is embraced by compounds of the general structure:

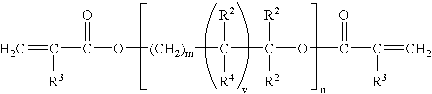

where R² is selected from hydrogen, alkyl of 1 to about 4 carbon atoms, hydroxyalkyl of 1 to about 4 carbon atoms or

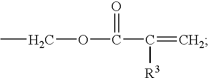

R³ is selected from hydrogen, halogen, and alkyl of 1 to about 4 carbon atoms and C₁₋₈ mono- or bicycloalkyl, a 3 to 8 membered heterocyclic radical with a maximum of 2 oxygen atoms in the ring;

R⁴ is selected from hydrogen, hydroxy and

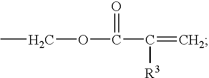

m is an integer from about 1 to about 8;

n is an integer from about 1 to about 20; and

v is 0 or 1.

In one aspect of the present invention, the boron-containing initiator includes an alkyl borohydride.

Desirably, the alkyl borohydride is embraced by compounds of the following structure:

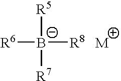

where R⁵ is a C₁ to C₁₀ alkyl,

R⁶, R⁷ and R⁸ which may be the same or different, are H, C₁ to C₁₀ alkyl, C₃ to C₁₀ cycloalkyl, phenyl, phenyl-substituted C₁ to C₁₀ alkyl, or phenyl substituted C₃ to C₁₀ cycloalkyl, provided that any two of R⁵, R⁶, R⁷ and R⁸ may optionally be part of a carbocyclic ring, and

M⁺ is a metal ion, an alkyloxy metal ion, an alkali metal ion, a quaternary ammonium cation, and combinations thereof.

Useful, but non-limiting, alkyl borohydride initiators include lithium triethylborohydride; sodium triethylborohydride; potassium triethylborohydride; sodium tetraethyl borate; lithium tetraethyl borate; lithium phenyl triethyl borate; tetramethylammonium phenyl triethyl borate; tetra methyl ammonium phenyl tri-n-butyl borate; lithium tri-sec-butylborohydride; sodium tri-sec-butylborohydride; potassium tri-sec-butylborohydride; lithium triethylborodeuteride; lithium 9-borobicyclo [3.31]-nonane (9BBN) hydride; lithium thexylborohydride; lithium trisiamylborohydride; and potassium trisiamylborohydride. Additional details may be found in U.S. Patent Application Publication No. US 2003/0226472 A1 and in International Patent Publication Nos. WO 02/34851 A1 and WO 02/34852 A1, the contents all of which are incorporated herein by reference.

In another aspect of the present invention, the boron-containing initiator includes an alkyl borohydride which is embraced by compounds of the following structure:

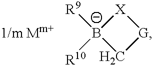

where X is O, S, or CHR¹³;

G is —(CR¹¹R¹²)ₙ— or

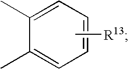

R⁹ and R¹⁰, which may be the same or different, are substituted or unsubstituted C₁₋₁₀ alkyl, or unsubstituted aryl or substituted aryl groups having from about 6 to about 12 carbon atoms;

R¹¹, R¹² and R¹³, which may be the same or different, are hydrogen, substituted or unsubstituted C₁₋₁₀ alkyl, substituted or unsubstituted C₁₋₁₀ alkylene, unsubstituted aryl, substituted aryl groups having from about 7 to about 12 carbon atoms;

n is the integer from about 1 to about 5;

M is a Group IA metal, Group IIA metal, ammonium, tetraalkylammonium, phosphonium, or metal complex; and

m is from +1 to +7.

Desirably, M is a Group IA metal such as lithium (Li⁺), sodium (Na⁺), or potassium (K⁺). Additional details of such metal alkyl borohydrides may be found International Patent Publication No. WO 03/040151 A1, the contents of which are incorporated herein by reference.

The boron-containing initiator may further include a polyfunctional aziridine or may be a complex of an organoborane and polyaziridine. A useful, but nonlimiting, organoborane/polyaziridine complex is embraced by compounds of the following structure:

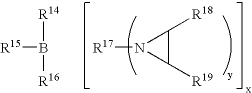

where R¹⁴ is a C₁₋₁₀ alkyl;

R¹⁵ and R¹⁶, which may be the same or different, are C₁₋₁₀ alkyl, C₃₋₁₀ cycloalkyl, phenyl, phenyl substituted C₁₋₁₀ alkyl or C₃₋₁₀ cycloalkyl, provided that any two of R¹⁴, R¹⁵ and R¹⁶ may optionally be part of a: carbocyclic ring;

R¹⁷ is a polyvalent C₁₋₆₀ alkyl, C₆₋₆₅ aryl, C₇₋₆₆ alkylaryl, optionally substituted or interrupted by one or more hetero-atoms or hetero-atom containing groups;

R¹⁸ and R¹⁹, which may be the same or different, are H or C₁₋₁₀ alkyl;

y from about 1 to about 4; and

x is from about 2 to about 15, provided that y is at least 1.3 times greater than x.

Useful, but non-limiting, polyaziridines, whether used alone or as a complex, include trimethylol propane tris(3-(2-methyl aziridine))propionate, trimethylol propane tris-3-N-aziridinyl propionate, pentaerythritol tris(3-(2-methyl aziridine))propionate, and pentaerythritol tris(3-(1-aziridinyl))propionate.

The boron-containing initiator may also be a complex of a trialkyl borane or alkyl cycloalkyl borane and an amine compound,

where the amine compound of the organoborane/amine complex is selected from the group consisting of (1) amines having an amidine structural component; (2) aliphatic heterocycles having at least one nitrogen in the heterocyclic ring, where the heterocyclic compound may also contain one or more nitrogen atoms, oxygen atoms, sulfur atoms, or double bonds in the heterocycle; (3) primary amines which, in addition, have one or more hydrogen bond accepting groups where there are at least two carbon atoms between the primary amine and the hydrogen bond accepting group, such that due to inter- or intramolecular interactions within the complex, the strength of the B—N bond is increased; and (4) conjugated imines; and

where the trialkyl borane or alkyl cycloalkyl borane corresponds to the formula:

the primary amine corresponds to the formula:

NH₂(CH₂)b-(C(R²¹)₂)ₐ;

the organoborane heterocyclic amine complex corresponds to the formula:

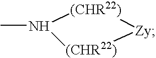

the organoborane amidine complex corresponds to the formula:

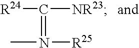

and
the organoborane conjugated imine complex corresponds to the formula

—NR²⁵═CR²⁶—(CR²⁶═CR²⁶)_{c};

where B is boron;

R²⁰ is a C₁₋₁₀ alkyl, C₃₋₁₀ cycloalkyl or a cycloaliphatic ring structure formed from two or more of the C₁₋₁₀ alkyl or the C₃₋₁₀ cycloalkyl;

R²¹ hydrogen, a C₁₋₁₀ alkyl or C₃₋₁₀ cycloalkyl;

R²² is hydrogen, a C₁₋₁₀ alkyl or C₃₋₁₀ cycloalkyl;

R²² is hydrogen, a C₁₋₁₀ alkyl or C₃₋₁₀ cycloalkyl;

R²³, R²⁴ and R²⁵, which may be the same or different, are hydrogen, C₁₋₁₀ alkyl, C₃₋₁₀ cycloalkyl, or two or more of R²³, R²⁴ and R²⁵ in any combination can combine to form a ring structure which can be a single ring or a multiple ring structure and the ring structure can include one or more of nitrogen, oxygen or unsaturation in the ring structure;

R²⁶ is hydrogen, C₁₋₁₀ alkyl or C₃₋₁₀ cycloalkyl, Y, —(C(R²⁶)₂—(CR²⁶═CR²⁶)_{c}—Y or two or more of R²⁶ can combine to form a ring structure, or one or more of R² can form a ring structure with Y provided the ring structure is conjugated with respect to the double bond of the imine nitrogen; Y is independently in each occurrence hydrogen, N(R²⁷)₂, OR²⁷, C(O)OR²⁷, a halogen or an alkylene group which forms a cyclic ring with R²⁵ or R²⁶;

R²⁷ is hydrogen, C₁₋₁₀ alkyl, C₃₋₁₀ cycloalkyl, C₆₋₁₀ aryl or alkaryl;

Z is oxygen or —NR²⁷;

a is an integer of from 1 to 10;

b is 0 or 1, with the proviso that the sum of a and b should be from 2 to 10;

c is an integer of from 1 to 10;

x is an integer of 1 to 10, with the proviso that the total of all occurrences of x is from 2 to 10; and

y is separately in each occurrence 0 or 1.

Desirably, the complex has a molar ratio of the amine compound to the borane compound from about 1.0:1.0 to about 3.0:1.0. Nonlimiting examples of useful primary amines include dimethylaminopropyl amine, methoxypropyl amine, dimethylaminoethylamine, dimethylaminobutylamine, methoxybutyl amine, methoxyethyl amine, ethoxypropylamine, propoxypropylamine, amine terminated polyalkylene ethers, such as trimethylolpropane tris(poly(propyleneglycol), amine-terminated ether, aminopropylmorpholine, isophoronediamine, and aminopropylpropanediamine. Nonlimiting examples of the organoborane heterocyclic amine complexes include morpholine, piperidine, pyrrolidine, piperazine, 1,3,3-trimethyl 6-azabicyclo[3.2.1]octane, thiazolidine, homopiperazine, aziridine, 1,4-diazabicylo[2.2.2]octane (DABCO), 1-amino-4-methylpiperazine, and 3-pyrroline. Nonlimiting examples of useful amidines include 1,8-diazabicyclo[5,4]undec-7-ene; tetrahydropyrimidine; 2-methyl-2-imidazoline; and 1,1,3,3-tetramethylguanidine. Useful conjugated imines include 4-dimethylaminopyridine; 2,3-bis(dimethylamino)cyclopropeneimine; 3-(dimethylamine) acroleinimine; and 3-(dimethylamino)methacroleinimine. Additional details may be found in U.S. Patent Application No. 2002/0195453 A1, the contents of which is incorporated herein by reference.

In one aspect of the present invention, a method for forming an electrochemical cell includes the steps of (a) providing a first and a second electrochemical cell component each having a mating surface; (b) applying a curable sealant composition to the mating surface of at least one of the first electrochemical cell component or the second electrochemical cell component, where the curable sealant composition comprises a polymerizable (meth)acrylate component and a boron-containing initiator; (c) curing the sealant composition; and (d) aligning the mating surface of the second electrochemical cell component with the mating surface of the first electrochemical cell component.

In another aspect of the present invention, a method for forming an electrochemical cell includes the steps of (a) providing a first electrochemical cell component having a mating surface; (b) aligning a mating surface of a second electrochemical cell component with the mating surface of the first electrochemical cell component; (c) applying a curable sealant composition to at least a portion of the mating surface of at least one of the first or second electrochemical cell component, where the curable sealant composition comprises a polymerizable (meth)acrylate component and a boron-containing initiator; and

(d) curing the sealant composition.

The adhesive compositions of the present invention may also include certain fillers for example, lithopone, zirconium silicate, hydroxides, such as hydroxides of calcium, aluminum, magnesium, iron and the like, diatomaceous earth, carbonates, such as sodium, potassium, calcium, and magnesium carbonates, oxides, such as zinc, magnesium, chromic, cerium, zirconium and aluminum oxides, calcium clay, fumed silicas, treated silicas, precipitated silicas, untreated silicas, graphite, synthetic-fibers and mixtures thereof, provided that the fillers do not contain significant amounts of water-extractable ionic materials.

The filler may be used in an amount within the range of about 1% to 70% by weight of the total composition, such as about 10% to about 50% by weight.

Other additives can also be incorporated into the inventive compositions, provided they do not adversely affect the ability of the compositions to seal or bond fuel cell components or to otherwise adversely affect the performance of the fuel cell. For example, an adhesion promoter can be added to the inventive compositions. Such an adhesion promoter can include, for example, octyl trimethoxysilane (commercially available from Witco Corporation, Greenwich, Conn. under the trade designation A-137), glycidyl propyl trimethoxysilane (commercially available from Witco under the trade designation A-187), methacryloxypropyl trimethoxysilane (commercially available from Witco under the trade designation A-174), vinyl trimethoxysilane, methyltrimethoxysilane, vinyltrimethoxysilane, methyltriethoxysilane, vinyltriethoxysilane, enoxysilanes, tetraethoxysilane and combinations thereof. Desirably, the adhesion promoter is glycidyl propyl trimethoxysilane, vinyl trimethoxysilane and combinations thereof.

The adhesion promoters, when present, may be used in an amount within the range of about 0.05 to about 2% by weight of the total composition.

The silicone compositions of the present invention may also include additional crosslinkers. The additional crosslinkers are those capable of reacting with vinyl-terminated and/or hydride-functionalized polydimethylsiloxanes. For instance, trimethylsilyl-terminated hydrogenmethyl dimethyl siloxane copolymer with two or more hydrides per molecule (commercially available from PPG Industries as MASIL XL-1) is appropriate for use herein. Other conventionally known crosslinkers can also be used with the present compositions provided they are able to crosslink the present compositions through an addition cure mechanism without adversely affecting the adhesive and sealant properties of the fuel cell assembly.

In addition, to modify the dispensing properties through viscosity adjustment, a thixotropic agent may also be included. The thixotropic agent may be used in an amount within the range of about 0.05 to about 25% by weight of the total composition. Examples of such a thixotropic agent include reinforcing silicas, such as fused or fumed silicas, and may be untreated or treated so as to alter the chemical nature of their surface. Virtually any reinforcing fused, precipitated or fumed silica may be used.

Examples of such treated fumed silicas include polydimethylsiloxane-treated silicas and hexamethyldisilazane-treated silicas. Such treated silicas are commercially available, such as from Cabot Corporation under the tradename CAB-O-SIL ND-TS and Degussa Corporation under the tradename AEROSIL, such as AEROSIL-R805.

Of the untreated silicas, amorphous and hydrous silicas may be used. For instance, commercially available amorphous silicas include AEROSIL 300 with an average particle size of the primary particles of about 7 nm, AEROSIL 200 with an average particle size of the primary particles of about 12 nm, AEROSIL 130 with an average size of the primary particles of about 16 nm; and commercially available hydrous silicas include NIPSIL E150 with an average particle size of 4.5 nm, NIPSIL E200A with and average particle size of 2.0 nm, and NIPSIL E220A with an average particle size of 1.0 nm (manufactured by Japan Silica Kogya Inc.).

Hydroxyl-functional alcohols are also well-suited as the thixotropic agent, such as tris[copoly(oxypropylene)(oxypropylene)]ether of trimethylol propane, and [H(OC₂H₆)ₓ(OC₂H₄)_{y}—O—CH₂]₃—C—CH₂—CH₃, where x and y are each integers that may be the same or different and are within the range of about 1 to about 8,000, and is available commercially from BASF Wyandotte Corp., Wyandotte, Mich. under the tradename PLURACOL V-10.

4. The cell of claim 2, wherein the plastic or plastic-containing substrate is a molded substrate selected from the group consisting of an injection molded substrate, a compression molded substrate and combinations thereof.

5. The cell of claim 2, wherein the substrate is a machined substrate or a vacuum-formed substrate.

6. The cell of claim 2, wherein the plastic or plastic-containing substrate is electrically conductive or includes electrically conductive particles.

7. The cell of claim 1, wherein the cured composition is adhesively bonded to the mating surface of the first cell, and further wherein the cured sealant composition is adhesively bonded to the mating surface of the second fuel cell.

8. The cell of claim 1, wherein the cured composition is adhesively bonded to the mating surface of the first cell, and further wherein the cured sealant composition is not adhesively bonded to the mating surface of the second fuel cell.

9. The cell of claim 1, wherein the first cell component is selected from the group consisting of a cathode flow field plate, an anode flow field plate, a gas diffusion layer, an anode catalyst layer, a cathode catalyst layer, a membrane electrolyte, a membrane-electrode-assembly frame, and combinations thereof.

10. The cell of claim 9, wherein the second cell component is selected from the group consisting of a cathode flow field plate, an anode flow field plate, a gas diffusion layer, an anode catalyst layer, a cathode catalyst layer, a membrane electrolyte, a membrane-electrode-assembly frame, and combinations thereof, provided that the second cell component is different from the first cell component.

11. The cell of claim 1, wherein the cured sealant composition comprises a curable (meth)acrylate component, wherein the curable (meth)acrylate component comprises a mono-functional (meth)acrylate component, a poly-functional (meth)acrylate component, and combinations thereof.

12-13. (canceled)

14. The cell of claim 1, wherein the boron-containing initiator comprises an alkyl borohydride.

15. The cell of claim 14, wherein the alkyl borohydride is embraced by compounds of the following structure: 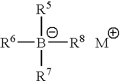
wherein R⁵ is a C₁ to C₁₀ alkyl,
R⁶, R⁷ and R⁸ which may be the same or different, are H, C₁ to C₁₀ alkyl, C₃ to C₁₀ cycloalkyl, phenyl, phenyl-substituted C₁ to C₁₀ alkyl, or phenyl substituted C₃ to C₁₀ cycloalkyl, provided that any two of R¹, R², R³ and R⁴ may optionally be part of a carbocyclic ring, and
M⁺ is a metal ion, an alkyloxy metal ion, an alkali metal ion, a quaternary ammonium cation, and combinations thereof.

16. The cell of claim 14, wherein the alkyl borohydride is embraced by compounds of the following structure: 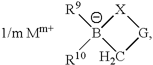
wherein X is O, S, or CHR¹³;
G is —(CR¹¹R¹²)ₙ— or 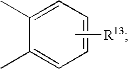
R⁹ and R¹⁰, which may be the same or different, are substituted or unsubstituted C₁₋₁₀ alkyl, or unsubstituted aryl or substituted aryl groups having from about 6 to about 12 carbon atoms;
R¹¹, R¹² and R¹³, which may be the same or different, are hydrogen, substituted or unsubstituted C₁₋₁₀ alkyl, substituted or unsubstituted C₁₋₁₀ alkylene, unsubstituted aryl, substituted aryl groups having from about 7 to about 12 carbon atoms;
n is the integer from about 1 to about 5;
M is a Group IA metal, Group IIA metal, ammonium, tetraalkylammonium, phosphonium, or metal complex; and
m is from +1 to +7.

17. The cell of claim 1, wherein the boron-containing initiator further includes a polyfunctional aziridine.

18. The cell of claim 1, wherein the boron-containing initiator is a complex of an organoborane and polyaziridine, wherein the organoborane/polyaziridine complex is embraced by compounds of the following structure: 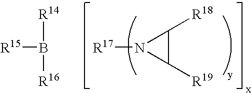
wherein R¹⁴ is a C₁₋₁₀ alkyl;
R¹⁵ and R¹⁶, which may be the same or different, are C₁₋₁₀ alkyl, C₃₋₁₀ cycloalkyl, phenyl, phenyl substituted C₁₋₁₀ alkyl or C₃₋₁₀ cycloalkyl, provided that any two of R¹⁴, R¹⁵ and R¹⁶ may optionally be part of a carbocyclic ring;
R¹⁷ is a polyvalent C₁₋₆₀ alkyl, C₆₋₆₅ aryl, C₇₋₆₆ alkylaryl, optionally substituted or interrupted by one or more hetero-atoms or hetero-atom containing groups;
R¹⁸ and R¹⁹, which may be the same or different, are H or C₁₋₁₀ alkyl;
y from about 1 to about 4; and
x is from about 2 to about 15, provided that y is at least 1.3 times greater than x.

19. The cell of claim 1, wherein the boron-containing initiator is a complex of a trialkyl borane or alkyl cycloalkyl borane and an amine compound,
wherein the amine compound of the organoborane/amine complex is selected from the group consisting of (1) amines having an amidine structural component; (2) aliphatic heterocycles having at least one nitrogen in the heterocyclic ring, wherein the heterocyclic compound may also contain one or more nitrogen atoms, oxygen atoms, sulfur atoms, or double bonds in the heterocycle; (3) primary amines which, in addition, have one or more hydrogen bond accepting groups wherein there are at least two carbon atoms between the primary amine and the hydrogen bond accepting group, such that due to inter- or intramolecular interactions within the complex, the strength of the B—N bond is increased; and (4) conjugated imines; and
wherein the trialkyl borane or alkyl cycloalkyl borane corresponds to the formula:
the primary amine corresponds to the formula:
NH₂(CH₂)b-(C(R²¹)₂)ₐ;
the organoborane heterocyclic amine complex corresponds to the formula: 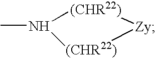
the organoborane amidine complex corresponds to the formula: 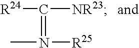
the organoborane conjugated imine complex corresponds to the formula
—NR²⁵═CR²⁶—(CR²⁶═CR²⁶)_{c};
wherein B is boron;
R²⁰ is a C₁₋₁₀ alkyl, C₃₋₁₀ cycloalkyl or a cycloaliphatic ring structure formed from two or more of the C₁₋₁₀ alkyl or the C₃₋₁₀ cycloalkyl;
R²¹ is hydrogen, a C₁₋₁₀ alkyl or C₃₋₁₀ cycloalkyl;
R²² is hydrogen, a C₁₋₁₀ alkyl or C₃₋₁₀ cycloalkyl;
R²³, R²⁴, and R²⁵, which may be the same or different are hydrogen, C₁₋₁₀ alkyl, C₃₋₁₀ cycloalkyl, or two or more of R²³, R²⁴ and R²⁵ in any combination can combine to form a ring structure which can be a single ring or a multiple ring structure and the ring structure can include one or more of nitrogen, oxygen or unsaturation in the ring structure;
R²⁶ is hydrogen, C₁₋₁₀ alkyl or C₃₋₁₀ cycloalkyl, Y, —(C(R²⁶)₂—(CR²⁶═CR²⁶)_{c}—Y or two or more of R²⁶ can combine to form a ring structure, or one or more of R²⁶ an form a ring structure with Y provided the ring structure is conjugated with respect to the double bond of the imine nitrogen; Y is independently in each occurrence hydrogen, N(R²⁷)₂, OR²⁷, C(O)OR²⁷, a halogen or an alkylene group which forms a cyclic ring with R²⁵ or R²⁶;
R²⁷ is hydrogen, C₁₋₁₀ alkyl, C₃₋₁₀ cycloalkyl, C₆₋₁₀ aryl or alkaryl;
Z is oxygen or —NR²⁷;
a is an integer of from 1 to 10;
b is 0 or 1, with the proviso that the sum of a and b should be from 2 to 10;
c is an integer of from 1 to 10;
x is an integer of 1 to 10, with the proviso that the total of all occurrences of x is from 2 to 10; and
y is separately in each occurrence 0 or 1.

20. (canceled)

21. A method for forming an electrochemical cell comprising:
providing a first and a second electrochemical cell component each having a mating surface;
applying a curable sealant composition to the mating surface of at least one of the first electrochemical cell component or the second electrochemical cell component, wherein the curable sealant composition comprises a polymerizable (meth)acrylate component and a boron-containing initiator;
curing the sealant composition; and
aligning the mating surface of the second electrochemical cell component with the mating surface of the first electrochemical cell component.

22. A method for forming an electrochemical cell comprising:
providing a first electrochemical cell component having a mating surface;
aligning a mating surface of a second electrochemical cell component with the mating surface of the first electrochemical cell component;
applying a curable sealant composition to at least a portion of the mating surface of at least one of the first or second electrochemical cell components, wherein the curable sealant composition comprises a polymerizable (meth)acrylate component and a boron-containing initiator; and
curing the sealant composition.

23-26. (canceled)

27. The method of claim 21, wherein the boron-containing initiator comprises an alkyl borohydride, an organoborane/polyaziridine complex, a complex of a trialkyl borane or alkyl cycloalkyl borane and an amine compound, and combinations thereof.

28. The method of claim 21, wherein the electrochemical cell is a fuel cell.
